(19) United States
(12) Patent Application Publication
(10) Pub. No.: US 2020/0079176 A1
(43) Pub. Date: Mar. 12, 2020

(54) AIR CONDITIONER FOR VEHICLE

(71) Applicant: HANON SYSTEMS

(72) Inventors: Boo Yong UM, Daejeon (KR); Yong Sik KIM, Daejeon (KR)

(21) Appl. No.: 15/748,675

(22) PCT Filed: Jan. 29, 2016
(86) PCT No.: PCT/KR2016/001031

§ 371 Date: Jan. 30, 2018

(51) Int. Cl. B60H 1/00; B60H 1/32

(52) U.S. Cl. CPC B60H 1/00542; B60H 1/00064; B60H 1/00528; B60H 2001/00214; B60H 1/3233; B60H 2001/00135; B60H 2001/00192; B60H 1/00057

(57) ABSTRACT

The present invention relates to an air conditioner for a vehicle, which is configured in a semi-center mounting type having a separable evaporator unit to be assembled to a blower unit and a heater unit, such that the blower unit and the heater unit can be in common use even though the evaporator unit is manufactured according to the size of an evaporator, thereby reducing development costs and development time.

### BACKGROUND OF THE INVENTION

### Field of the Invention

The present invention relates to an air conditioner for a vehicle, and more particularly, to an air conditioner for a vehicle, which is configured in a semi-center mounting type having a separable evaporator unit to be assembled to a blower unit and a heater unit, such that the blower unit and the heater unit can be in common use even though the evaporator unit is manufactured according to the size of an evaporator, thereby reducing development costs and development time.

### Background Art

An air conditioner for a vehicle is an apparatus for cooling or heating the interior of the vehicle by cooling or heating through the process of introducing outdoor air into the interior of the vehicle or circulating indoor air of the vehicle. Such an air conditioner for a vehicle includes an evaporator for cooling the inside of an air-conditioning case; a heater core for heating the inside of the air-conditioning case; and a mode converting door for selectively blowing the air cooled by the evaporator or heated by the heater core toward parts of the interior of the vehicle.

According to independent structures of a blower unit, an evaporator unit and a heater core unit, such an air conditioner is classified into a three-piece type air conditioner in which the blower unit, the evaporator unit and the heater core unit are disposed independently, a semi-center type air conditioner in which the evaporator unit and the heater core unit are embedded in the air-conditioning case and the blower unit is mounted separately, and a center-mounting type air conditioner in which the three units are all embedded in the air-conditioning case.

FIG. 1 is a schematic diagram of a conventional air conditioner for a vehicle. As shown in FIG. 1, the air conditioner 1 includes: a blower unit 10, which has an indoor air inflow port 21 and an outdoor air inflow port 22 formed at one side thereof, an indoor and outdoor air converting door 23 for selectively opening and closing the indoor air inflow port 21 and the outdoor air inflow port 22, and a blower fan 35 for forcedly blowing indoor air and outdoor air toward an air inflow port 43; and an air-conditioning case 40, which has the air inflow port 43 for introducing the air blown from the blower unit 10 and a plurality of air outflow port 44 for discharging the air, and in which an evaporator 41 and a heater core 42 are arranged to be spaced apart from each other at a predetermined interval in consecutive order.

FIG. 2 is a perspective view of a conventional semi-center mounting type air conditioner 1 out of the above-mentioned air conditioner. The air conditioner 1 includes: an air-conditioning case which has an air inflow port 43 formed at an inlet and a plurality of air outflow ports 44 formed at an outlet; and a blower unit 10, which selectively introduces indoor air and outdoor air through an indoor air inflow port 21 and an outdoor air inflow port 22 formed at the upper portion thereof to forcedly blow the indoor air or outdoor air toward the air inflow port 43.

Moreover, an evaporator 41 and a heater core 42 are mounted inside the air-conditioning case 40 in order, and the semi-center mounting type air conditioner further includes a temperature adjusting door (not shown) for adjusting temperature and a plurality of mode doors (not shown) for performing various air-conditioning modes. The temperature adjusting door and the mode doors mounted inside the air-conditioning case 40.

As described above, the semi-center mounting type air conditioner 1 is configured in such a way that the evaporator 41 and the heater core 42 are mounted together inside the air-conditioning case 40 and the blower unit 10 is separately assembled to the side of the air-conditioning case 40.

According to the semi-center mounting type air conditioner 1, the air blown into the air-conditioning case 40 by operation of the blower unit 10 passes through the evaporator 41, and then, the air is cooled or heated by the temperature adjusting door while selectively passing through the heater core 42. The cooled or heated air is supplied to the interior of the vehicle through various ducts (not shown) connected with the air outflow ports 44 so as to heat or cool the interior of the vehicle.

However, the semi-center mounting type air conditioner 1 requires evaporators 41 of different sizes according to demand performance of the evaporator 41. In this instance, because the evaporator 41 and the heater core 42 are mounted together inside the air-conditioning case 40, if the size of the evaporator 41 is changed, the air-conditioning case 40 must be developed newly.

In other words, the semi-center mounting type air conditioner 1 requires lots of development costs and development time because the air-conditioning case 40 must be developed newly due to a change in size of the evaporator 41 even though the heater core 42 is not changed in size.

### SUMMARY OF THE INVENTION

Accordingly, the present invention has been made in view of the above-mentioned problems occurring in the prior art, and it is an object of the present invention to provide an air conditioner for a vehicle, which is configured in a semi-center mounting type having a separable evaporator unit to be assembled to a blower unit and a heater unit, such that the blower unit and the heater unit can be in common use even though the evaporator unit is manufactured according to the size of an evaporator, thereby reducing development costs and development time.

To accomplish the above object, according to the present invention, there is provided an air conditioner for a vehicle including: a blower unit, which has a blower fan mounted therein, indoor and outdoor air inflow ports formed at the upstream side of the blower fan, and an outlet formed at the downstream side; a heater unit, which has a warm air passageway in which the heater core, a cold air passageway bypassing the heater core, and a plurality of air outflow ports for discharging the air passing through the cold air passageway and the warm air passageway to the interior of the vehicle; and an evaporator unit, which has an evaporator therein, and is connected and assembled between the outlet of the blower unit and an inlet of the heater unit, such that the air discharged from the outlet of the blower unit is supplied to the heater unit after passing through the evaporator, wherein the evaporator unit is manufactured by size of the evaporator and the blower unit and the heater unit are in common use.

As described above, according to a preferred embodiment of the present invention, the air conditioner for a vehicle is configured in a semi-center mounting type having the separable evaporator unit to be assembled to the blower unit and the heater unit, such that the blower unit and the heater unit can be in common use even though the evaporator unit is manufactured according to the size of an evaporator, thereby reducing development costs and development time.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a configurative view of a conventional air conditioner for a vehicle;

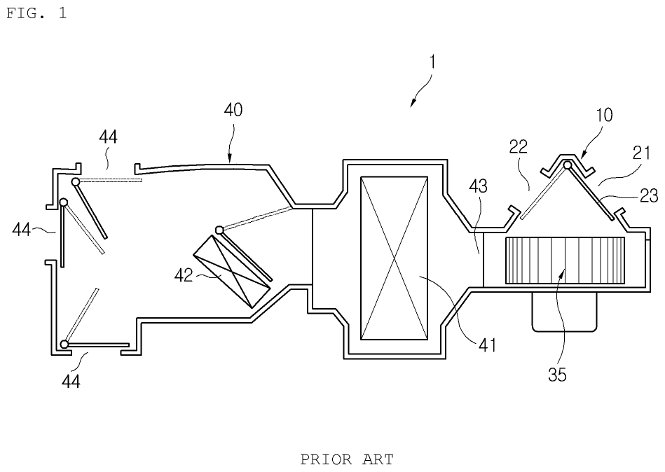

FIG. 2 is a perspective view of a conventional semi-center mounting type air conditioner;

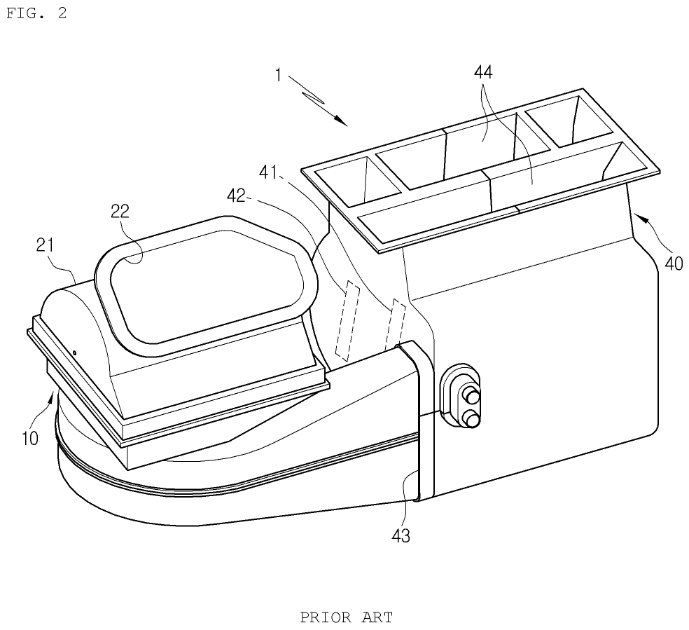

FIG. 3 is a perspective view of an air conditioner for a vehicle according to a preferred embodiment of the present invention;

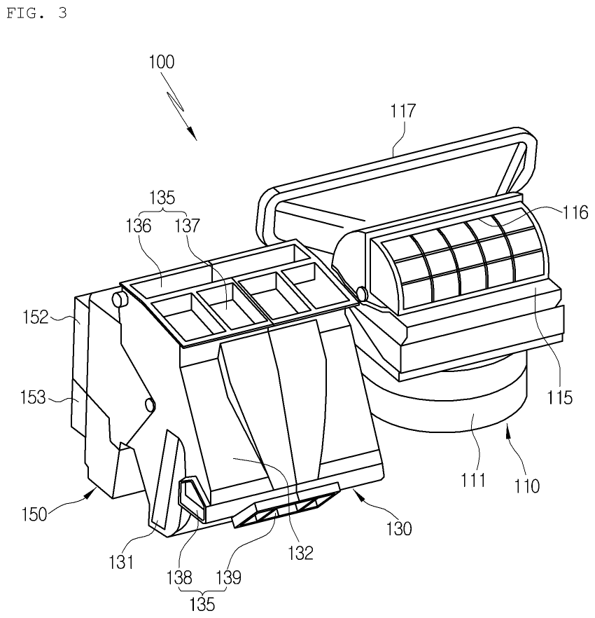

FIG. 4 is a perspective view showing a state where a blower unit is separated from an evaporator unit of the air conditioner for the vehicle according to the preferred embodiment of the present invention;

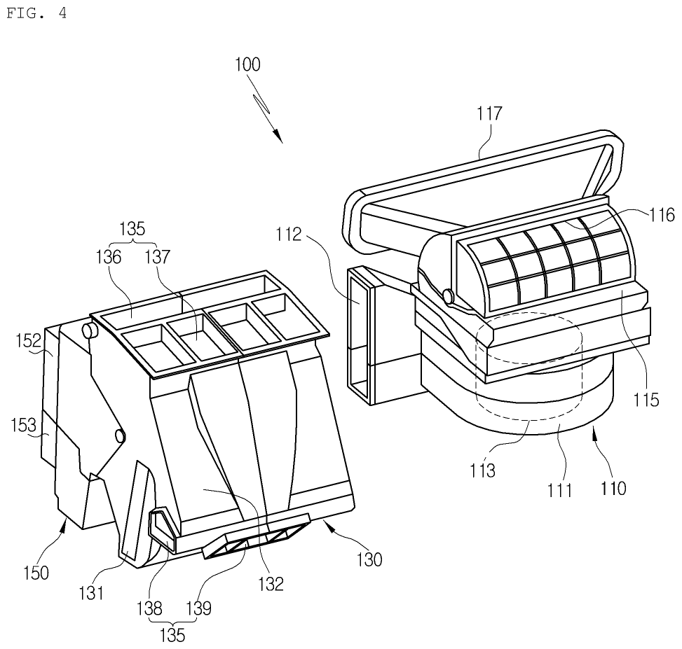

FIG. 5 is a perspective view showing a state where the evaporator unit and a heater unit are separated from the air conditioner according to the preferred embodiment of the present invention;

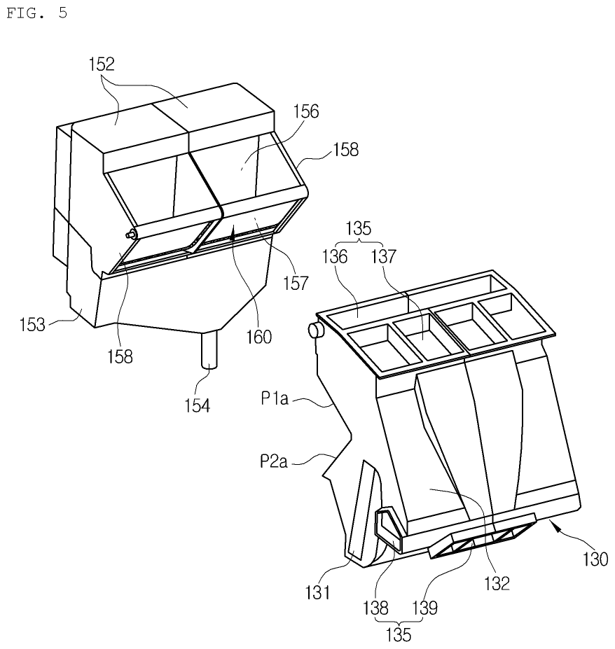

FIG. 6 is an exploded perspective view showing the evaporator unit of the air conditioner for the vehicle according to the preferred embodiment of the present invention; and

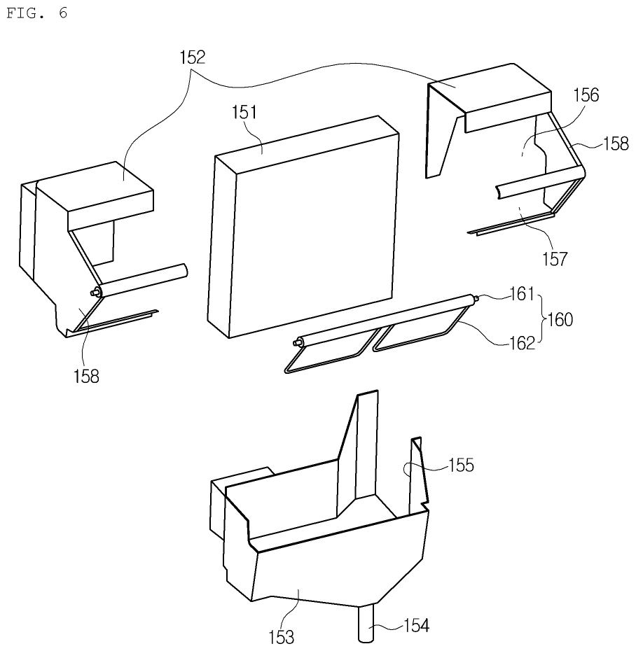

FIG. 7 is a sectional view showing a state where the evaporator unit and the heater unit are combined in the air conditioner for the vehicle according to the present invention.

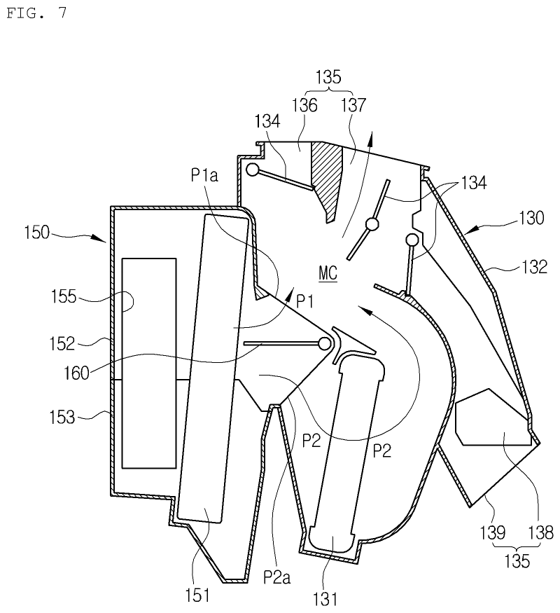

### DETAILED DESCRIPTION OF THE PREFERRED EMBODIMENT

Hereinafter, reference will be now made in detail to the preferred embodiments of the present invention with reference to the attached drawings.

As shown in the drawing, an air conditioner 100 for a vehicle according to a preferred embodiment of the present invention includes a blower unit 110, and an evaporator unit 150, which are independently configured to be assembled with each other.

In other words, the conventional air conditioner for a vehicle has all of an evaporator and a heater core inside one air-conditioning case, but the air conditioner 100 for the vehicle according to the present invention has the evaporator unit 150, which is separable from the heater unit 130. Therefore, the evaporator unit 150 is manufactured by size according to demand performance of an evaporator 151, and the blower unit 110 and the heater unit 130 are in common use.

The blower unit 110 includes a blower fan 113 mounted therein, indoor and outdoor air inflow ports 116 and 117 formed at the upstream side of the blower fan 113, and an outlet 112 formed at the downstream side.

In more detail, the blower unit 110 includes: an intake duct 115, which has the indoor air inflow port 116 and the outdoor air inflow port 117 formed at the upper part thereof and an indoor and outdoor air converting door (not shown) mounted therein for opening and closing the indoor and outdoor air inflow ports 116 and 117; and a scroll case 111, which is assembled to the lower part of the intake duct 115, and in which the blower fan 113 is mounted.

The scroll case 111 has a scrolled shape, and has an outlet 112 extending from a portion where the scrolled shape is ended.

Therefore, when the blower fan 113 operates, indoor air and outdoor air are inhaled through the indoor air inflow port 115 and the outdoor air inflow port 117, and the inhaled indoor air and outdoor air flow along the scrolled shape inside the scroll case 111, and then, are discharged to the outlet 112.

In the meantime, because the outlet 112 of the blower unit 110 is assembled with an air inflow port 155, which is an inlet of the evaporator unit 150, the air discharged from the outlet 112 is supplied to the inside of the evaporator unit 150.

Moreover, the heater unit 130 includes: a warm air passageway P2 in which the heater core 131 is mounted; a cold air passageway P1 bypassing the heater core 131; and a plurality of air outflow ports 135 for discharging the air passing through the cold air passageway P1 and the warm air passageway P2 to the interior of the vehicle.

That is, the heater unit 130 has a heater case 132, in which the cold air passageway P1 and the warm air passageway P2 are formed, and the heater core 131 is mounted on the warm air passageway P2 of the heater case 132.

In this instance, at an inlet of the heater case 132 assembled with the evaporator unit 150, formed are an inlet P1a of the cold air passageway P1 and an inlet P2a of the warm air passageway P2.

The inlet P1a of the cold air passageway P1 and the inlet P2a of the warm air passageway P2 are formed at predetermined angles. In this instance, the cold air passageway P1 makes the air, which is introduced into the inlet P1a of the cold air passageway P1, bypass the warm air passageway P2 and the heater core 131, and the warm air passageway P2 makes the air, which is introduced into the inlet P2a of the warm air passageway P2, pass through the heater core 131.

Furthermore, an outlet of the warm air passageway P2 joins the cold air passageway P1.

The plural air outflow ports 135 include a defrost vent 136, a face vent 137 and floor vents 138 and 139 formed at an outlet of the heater case 132.

The defrost vent 136 discharges wind toward a front window of the vehicle, the face vent 137 discharges wind toward a passenger's face, and the floor vents 138 and 139 discharge wind toward passengers' feet.

In the meantime, the floor vents 138 and 139 are divided into the floor vent 138 for the front seat and the floor vent 139 for the rear seat.

Additionally, mode doors 134 are respectively mounted at the air outflow ports 135 to control the degree of opening of the air outflow ports 135 according to air discharge modes.

In addition, the evaporator unit 150 has the evaporator 151 therein, and is connected and assembled between the outlet of the blower unit 110 and the inlet of the heater unit 130, such that the air discharged from the outlet 112 of the blower unit 110 is supplied to the heater unit 130 after passing through the evaporator 151.

That is, the conventional semi-center mounting type air conditioner has the structure that the evaporator and the heater core are all mounted inside one air-conditioning case, but the air conditioner according to the preferred embodiment of the present invention has the evaporator 151, which is a separated unit.

Therefore, the outlet 112 of the blower unit 110 is assembled to the side of the evaporator unit 150, and the inlet of the heater unit 130 is assembled to the rear side of the evaporator unit 150. That is, the blower unit 110 and the heater unit 130 are arranged and assembled at right angles to the evaporator unit 150.

In other words, the evaporator unit 150 and the blower unit 110 are arranged in the width direction of the vehicle to be assembled to each other, and the evaporator unit 150 and the heater unit 130 are arranged in the length direction, namely, in the back-and-forth direction, of the vehicle to be assembled to each other.

In this instance, the blower unit 110 is connected and assembled with an upstream side passageway of the evaporator 151 in the air flow direction inside the evaporator unit 150, and the heater unit 130 is connected and assembled with a downstream side passageway of the evaporator 151 in the air flow direction inside the evaporator unit 150.

In the meantime, the air inflow port 155, which is the inlet, is formed at the side of the evaporator unit 150 and is assembled with the outlet 112 of the blower unit 110, and a cold air connection hole 156 and a warm air connection hole 157, which are outlets, are formed at the rear side of the evaporator unit 150.

Such an evaporator unit 150 includes: an upper case 152, which is divided into right and left cases to be assembled with each other and receives the upper part of the evaporator 151; and a single lower case 153, which is assembled to the lower part of the upper case 152 and receives the lower part of the evaporator 151.

That is, the evaporator 151 is inserted and mounted between the upper case 152, which is divided into two, and the single lower case 153.

Meanwhile, the air inflow port 155 is formed across the upper case 152 and the lower case 153.

Moreover, not shown in the drawings, but in another preferred embodiment of the evaporator unit 150, the evaporator unit 150 may include: a single upper case 152, which receives the upper part of the evaporator 151; and a single lower case 153, which is assembled to the lower part of the upper case and receives the lower part of the evaporator 151.

That is, the upper case 152 may not be divided into the right and left sides but be formed in a single form.

Furthermore, a drain part 154 is formed on the bottom surface of the lower case 153 to drain condensate water generated from the evaporator 151.

Additionally, a temperature adjusting door 160 is mounted on the evaporator unit 150 in order to control an air flow amounts of the cold air passageway P1 and the warm air passageway P2 of the heater unit 130 by adjusting the flow direction of the air passing through the evaporator 151.

Namely, in the present invention, the evaporator unit 150 is disposed separately and is assembled with the heater unit 130, and in this instance, the temperature adjusting door 160 is inserted into the evaporator unit 150.

In the case that the temperature adjusting door 160 is mounted on the evaporator unit 150, it is possible to design the temperature adjusting door 160 to have the size corresponding to the size of the evaporator 151 even when the evaporator 151 is changed in its size.

If the temperature adjusting door 160 is mounted on the heater unit 130, the temperature adjusting door 160 cannot cope with the change in size of the evaporator 151 because it cannot be changed in size.

As described above, because the evaporator 151 and the temperature adjusting door 160 are mounted on the evaporator unit 150, the heater unit 130 can be in common use.

Moreover, at the downstream side of the evaporator 151 of the evaporator unit 150, formed are the cold air connection hole 156 for supplying the air passing through the evaporator 151 to the cold air passageway P1 of the heater unit 130, and the warm air connection hole 157 for supplying the air to the warm air passageway P2 of the heater unit 130.

That is, the outlet of the rear side of the evaporator unit 150 includes the cold air connection hole 156 and the warm air connection hole 157.

Therefore, the air passing through the evaporator 151 is supplied to the cold air passageway P1 of the heater unit 130 through the cold air connection hole 156 or supplied to the warm air passageway P2 of the heater unit 130 through the warm air connection hole 157.

In this instance, the cold air connection hole 156 of the evaporator unit 150 is connected with the inlet P1a of the cold air passageway, and the warm air connection hole 157 of the evaporator unit 150 is connected with the inlet P2a of the warm air passageway of the heater unit 130.

Meanwhile, in the case that the evaporator unit 150 is changed in size according to the size of the evaporator 151, the inlet (air inflow port) of the evaporator unit 150, to which the outlet 112 of the blower unit 110 is assembled, has the same size as the outlet 112 of the blower unit 110, and the outlet of the evaporator unit 150 to which the inlet of the heater unit 130 is assembled, has the same size as the inlet of the heater unit 130.

Namely, it is preferable that the cold air connection hole 156 of the evaporator unit 150 and the inlet P1a of the cold air passageway of the heater unit 130 have the same size and the warm air connection hole 157 of the evaporator unit 150 and the inlet P2a of the warm air passageway of the heater unit 130 have the same size.

Moreover, the temperature adjusting door 160 is mounted between the cold air connection hole 156 and the warm air connection hole 157 to control the degree of opening of the cold air connection hole 156 and the warm air connection hole 157.

As described above, because the degree of opening of the cold air connection hole 156 and the warm air connection hole 157 is controlled by the temperature adjusting door 160, the air volume flowing the cold air passageway P1 and the warm air passageway P2 of the heater unit 130 is controlled, such that temperature of the air discharged to the interior of the vehicle can be controlled.

That is, the cold air flowing in the cold air passageway P1 and the warm air heated by the heater core 131 while flowing in the warm air passageway P2 reach appropriate temperature while being mixed in a mixing chamber MC inside the heater case 132, and then, the air of the appropriate temperature is discharged to the interior of the vehicle through the air outflow ports 135.

In the meantime, the temperature adjusting door 160 includes: a rotary shaft 161 rotatably combined to the evaporator unit 150; and a door plate 162 formed on the outer circumferential surface of the rotary shaft 161 to control the degree of opening of the cold air connection hole 156 and the warm air connection hole 157.

Additionally, the evaporator unit 150 further includes a support plate 158 for rotatably supporting the temperature adjusting door 160.

The support plate 158 protrudes from the rear surface of the upper case 152 of the evaporator unit 150 to support the rotary shaft 161 of the temperature adjusting door 160.

Hereinafter, the action of the air conditioner for the vehicle according to the preferred embodiment of the present invention will be described.

First, as described above, the blower unit 110, the evaporator unit 150 and the heater unit 130, which are formed separately, are assembled with one another to complete the air conditioner for the vehicle 100. In this instance, in the case that the size of the evaporator 151 is changed according to vehicle models or various design purposes, only the evaporator unit 150 is manufactured separately and the blower unit 110 and the heater unit 130 are in common use.

Continuously, when the wind blown when the blower fan 113 of the blower unit 110 is introduced into the air inflow port 155 of the evaporator unit 150, the flow direction of the wind is changed into a perpendicular direction, and then, the wind passes the evaporator 151.

In this instance, in a cooling mode, the wind is changed into cold air while passing through the evaporator 151.

The wind passing through the evaporator 151 is controlled in its flow direction by the temperature adjusting door 160. That is, in the cooling mode, the wind flows to the cold air passageway P1 of the heater unit 130 through the cold air connection hole 156 opened by the temperature adjusting door 160, and in a heating mode, the wind flows to the warm air passageway P2 of the heater unit 130 through the warm air connection hole 157 opened by the temperature adjusting door 160.

As described above, temperature of the air discharged to the air outflow ports 135 of the heater unit 130 is adjusted by the temperature adjusting door 160.

In the meantime, the air flowing through the cold air passageway P1 and the air heated by the heater core 131 while flowing through the warm air passageway P2 are mixed in the mixing chamber MC, and then, is discharged to the air outflow ports 135 of the heater unit 130, which is opened by the mode doors 134 according to the air discharge modes.

1. An air conditioner for a vehicle comprising:
a blower unit, which has a blower fan mounted therein, indoor and outdoor air inflow ports formed at the upstream side of the blower fan, and an outlet formed at the downstream side;
a heater unit, which has a warm air passageway in which the heater core, a cold air passageway bypassing the heater core, and a plurality of air outflow ports for discharging the air passing through the cold air passageway and the warm air passageway to the interior of the vehicle; and
an evaporator unit, which has an evaporator therein, and is connected and assembled between the outlet of the blower unit and an inlet of the heater unit, such that the air discharged from the outlet of the blower unit is supplied to the heater unit after passing through the evaporator,
wherein the evaporator unit is manufactured by size of the evaporator and the blower unit and the heater unit are in common use.

2. The air conditioner according to claim 1, wherein the outlet of the blower unit is assembled to the side of the evaporator unit and the inlet of the heater unit is assembled to the rear side of the evaporator unit, so that the evaporator unit and the blower unit are arranged in the width direction of the vehicle and the evaporator unit and the heater unit are arranged in the length direction of the vehicle.

3. The air conditioner according to claim 1, wherein the blower unit is connected and assembled with an upstream side passageway of the evaporator of the evaporator unit, and
wherein the heater unit is connected and assembled with a downstream side passageway of the evaporator of the evaporator unit.

4. The air conditioner according to claim 1, wherein a temperature adjusting door is mounted on the evaporator unit in order to control an air flow amounts of the cold air passageway and the warm air passageway of the heater unit by adjusting the flow direction of the air passing through the evaporator.

5. The air conditioner according to claim 4, wherein, at the downstream side of the evaporator of the evaporator unit, formed are a cold air connection hole for supplying the air passing through the evaporator to the cold air passageway of the heater unit and a warm air connection hole for supplying the air to the warm air passageway of the heater unit, and
wherein the temperature adjusting door is mounted between the cold air connection hole and the warm air connection hole to adjust the degree of opening of the cold air connection hole and the warm air connection hole.

6. The air conditioner according to claim 5, wherein the evaporator unit further includes a support plate for rotatably supporting the temperature adjusting door.

7. The air conditioner according to claim 1, wherein the evaporator unit comprises:
an upper case, which is divided into right and left cases to be assembled with each other and receives the upper part of the evaporator; and
a single lower case, which is assembled to the lower part of the upper case and receives the lower part of the evaporator.

8. The air conditioner according to claim 1, wherein the evaporator unit comprises:
a single upper case, which receives the upper part of the evaporator; and
a single lower case, which is assembled to the lower part of the upper case and receives the lower part of the evaporator.

9. The air conditioner according to claim 7, wherein a drain part is formed on the bottom surface of the lower case to drain condensate water generated from the evaporator.

10. The air conditioner according to claim 8, wherein a drain part is formed on the bottom surface of the lower case to drain condensate water generated from the evaporator.

11. The air conditioner according to claim 1, wherein in the case that the evaporator unit is changed in size according to the size of the evaporator, the inlet of the evaporator unit, to which the outlet of the blower unit is assembled, has the same size as the outlet of the blower unit, and the outlet of the evaporator unit to which the inlet of the heater unit is assembled, has the same size as the inlet of the heater unit.
